(19) United States
(12) Patent Application Publication
(10) Pub. No.: US 2024/0372377 A1
(43) Pub. Date: Nov. 7, 2024

(54) INTERNAL RECHARGEABLE BATTERY FOR POWERING AUXILIARY FUNCTIONS FOR POWER TOOLS

(71) Applicant: Emerson Professional Tools, LLC, Elyria, OH (US)

(72) Inventors: Nicholas Amaral, Medina, OH (US); Eric Williams, Rockford, IL (US)

(21) Appl. No.: 18/312,272

(22) Filed: May 4, 2023

(51) Int. Cl. H02J 7/00; H01M 10/44; H01M 10/46; H01M 50/247; H02J 7/34

(52) U.S. Cl. CPC H02J 7/0013; H01M 10/441; H01M 10/46; H01M 50/247; H02J 7/0063; H02J 7/342; H01M 2220/30

(57) ABSTRACT

A battery system for powering a power tool includes an electrically powered main function and an auxiliary function. The main system includes a removable main battery an auxiliary battery and a controller that causes the main battery to charge the auxiliary battery.

### FIELD

The field of the disclosure relates generally to power tools, and more particularly, internal rechargeable batteries for powering auxiliary functions on power tools.

### BACKGROUND

Power tools, such as cordless power tools (e.g., crimping and cutting tools, pipe threading tools, pipe fabrication tools, drain cleaners, etc.), typically include a battery or battery pack that supplies power to the power tool. Some power tools include a removable battery pack that is detachable from the power tool for recharging the removable battery, resulting in downtime of the power tool when there is no available power source to power one or more functions of the power tool.

In some known power tools, auxiliary functions may require consistent power to maintain the operation of the auxiliary functions while the removable main battery is being recharged. Auxiliary features may include real-time clocks, which need to maintain time data even when the main battery has been removed for recharging. Accordingly, at least some known power tools include an auxiliary battery that is contained within the power tool. These internal batteries may be replaceable coin cell batteries, which may be used for watches and other known small electronic devices. Conventionally, these coin cell batteries are not rechargeable and need to be properly disposed of after depletion. Furthermore, these coin cell batteries may deplete quickly when powering functions continuously, or powering functions that require significant power. In some cases, users may store an inventory of replaceable coin cell batteries, such that when the battery is depleted, the battery can be swapped with a new battery. Maintaining a battery inventory, replacing a battery, and properly disposing of the depleted battery is both time consuming and tedious. Additionally, the integrity of the functions powered by the coin cell battery may be limited or not available when the battery is low or depleted. For example, a real time clock would be reset to a default time and would have to be updated upon reconnection of a new battery.

Accordingly, it would be advantageous to create a power tool that overcomes these limitations.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, these statements are to be read in this light, and not as admissions of prior art.

### SUMMARY

In one aspect, a battery system for powering a power tool has an electrically powered main function and an electrically powered auxiliary function. The battery system includes a removable main battery connectable to the power tool, an auxiliary battery for powering the auxiliary function. The auxiliary battery is fixed within a cavity defined by a housing of the power tool. The battery system includes a controller connected to the main battery and the auxiliary battery. If the controller detects that the main battery is connected to the power tool, the controller causes the main battery to charge the auxiliary battery and the controller causes the main battery to power the main function and if the controller detects that one of i) the main battery is disconnected from the power tool, and ii) the main battery has a charge level less than a predetermined threshold, the controller causes the auxiliary battery to power the auxiliary function.

In another aspect, a power tool system including a power tool has an electrically powered main function and an electrically powered auxiliary function. The power tool includes a cavity defined by a housing, a removable main battery connectable to the power tool and an auxiliary battery for powering the auxiliary function. The auxiliary battery is fixed within a cavity defined by a housing of the power tool. The power tool includes a controller connected to the main battery and the auxiliary battery. If the controller detects that the main battery is connected to the power tool, the controller causes the main battery to charge the auxiliary battery and the controller causes the main battery to power the main function, and if the controller detects that one of i) the main battery is disconnected from the power tool, and ii) the main battery has a charge level less than a predetermined threshold, the controller causes the auxiliary battery to power the auxiliary function.

In another aspect, a method includes detecting if a main battery is one of i) disconnected from the power tool, and ii) has a charge level less than a predetermined threshold. If the main battery is detected as being connected, charging an auxiliary battery by the main battery, and powering a main function and an auxiliary function of the power tool using the main battery and if the main battery is detected as being disconnected or has a charge level less than a predetermined threshold, powering the auxiliary function of the power tool using the auxiliary battery.

Various refinements exist of the functions noted in relation to the above-mentioned aspects. Further functions may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example power tool, illustrated in the form of an electric crimping tool.

FIG. 2 is a block diagram of the power tool shown in FIG. 1.

FIG. 3 is a block diagram of a control system for use with the power tool shown in FIG. 1.

FIG. 4 is a block diagram of another control system for use with the power tool shown in FIG. 1.

FIG. 5 is a flow diagram illustrating an example process for powering auxiliary and main functions using the power tool shown in FIG. 1, which may be implemented by a controller shown in FIG. 2.

FIG. 6. is a decision diagram illustrating an example process for powering auxiliary and main functions using the power tool shown in FIG. 1, which may be implemented by a controller shown in FIG. 2.

FIG. 7 is a table showing symbols and an associated status.

FIG. 8 is a table showing inputs and outputs of a controller.

Corresponding reference characters indicate corresponding parts throughout the several views of the drawings.

### DETAILED DESCRIPTION

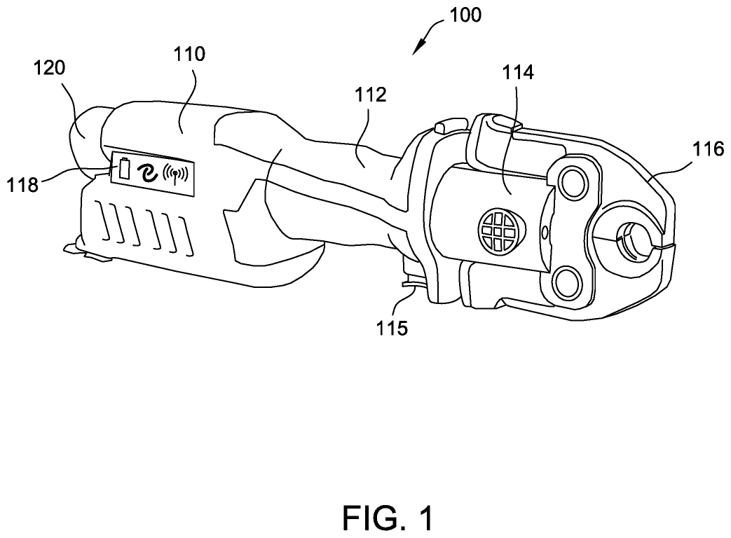

FIG. 1 is a perspective view of an example portable, power tool 100, illustrated in the form of an electric crimping tool 100. Although the tool 100 is shown and described herein with reference to a form of an electric crimping tool 100, the power tool 100 consistent with this disclosure may be embodied in other types and in other combinations including, for example and without limitation, hydraulic crimping and cutting tools, pipe threading tools, pipe fabrication tools, drain cleaning machines, conduit bending machines, cable pulling machines, and power tools, and equipment (e.g., power threading machines, pipe saws, impact driver, pipe beveling machines, drills, and drain cleaning machines).

The illustrated power tool 100 is a “cordless” power tool 100 including a portable and selectively connectable main battery 120 that is removably connected to a battery receptacle defined by the body 110 and an auxiliary battery 122 contained within the body 110 (not visible in FIG. 1). The main battery 120 is both selectively electrically and selectively mechanically connectable to the body 110. In other embodiments, the main battery 120 and the body 110 may have any suitable connection interface that enables the power tool 100 to function as described herein.

The power tool includes a handle 112 and a tool attachment 116, shown as a press jaw, although tool attachment 116 could be any of a variety of different attachments, for example, and without limitations, a cutter, crimper, etc. The tool 100 may include a tool attachment holder 114 for selectively attaching or detaching the tool attachment 116 to the power tool 100.

The handle 112 includes a trigger 115, the handle 112 may be sized and shaped to be gripped by the hands of an operator to facilitate performing an operation using the power tool 100 and allow the trigger 115 to be actuated by the operator, e.g., while the operator is gripping the handle 112.

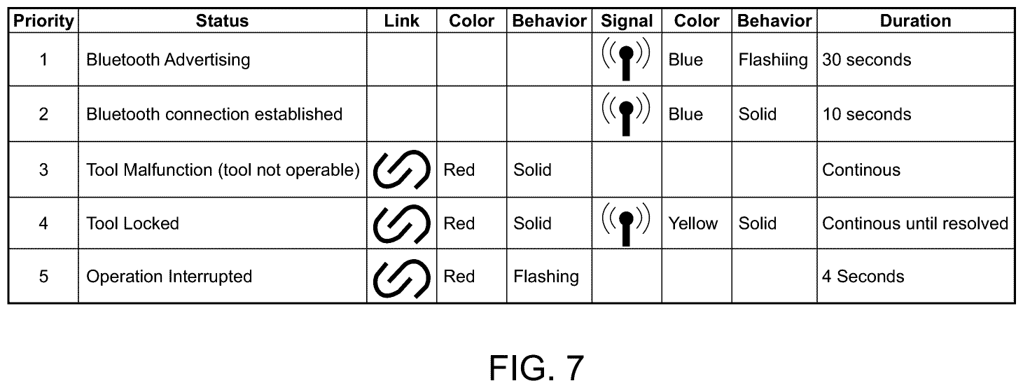

The tool 100 includes a user interface 118 that is connected to the body 110. The user interface 118 may include a display, such as LED (Light Emitting Diode) or LCD (Liquid-Crystal Display), and/or supports one or more user inputs, enabling the user to control the use of the tool attachment 116. The user interface may include one or more LED lights. The user interface 118 may provide real-time feedback to the user, such as, without limitation, cycle completion, work verification, errors, warnings, remaining battery life, and/or on/off switching, etc. The user interface 118 and the trigger 115 may be used alone or in combination to control the use of tool attachment 116. The user interface may display one or more symbols that indicate to a user a status of the power tool 100. For example, a first symbol may include a connectivity symbol that indicates that the connectively status of tool, e.g., indicating that a tool is or is not wirelessly connected to another device or the Internet. In another example, a second symbol may include a backlit symbol that indicates a notification, or a warning, of a fault condition of the power tool 100. The components and connections shown in FIG. 1 are a functional example only. Other embodiments may include different components, more or fewer components. One or more symbols and associated status is shown in FIG. 7. An individual symbol may have a color or behavior to indicate one or more of a different status.

The main battery and the auxiliary battery 122 may be a direct current (DC) source battery configured to supply direct current to the power tool 100. The main battery 120 and auxiliary battery 122 may have any suitable DC battery construction that enables the power tool 100 to function as described herein. For example, the main and auxiliary batteries 120, 122 may include, without limitation, one or more lithium-ion batteries, lithium-metal batteries, supercapacitors or other capacitor-based voltage sources, lithium nickel manganese cobalt oxide batteries, lithium nickel cobalt aluminum oxide batteries, and any other suitable DC battery construction that enables the power tool 100 to function as described herein. In this embodiment, the main battery 120 is a rechargeable lithium-ion battery that includes a plurality of lithium-ion cells.

In this embodiment, the auxiliary battery 122 is a single lithium-ion pouch cell that is fixed within the body of the power tool 100. The auxiliary battery 122 is not accessible to a user or an operator of the power tool 100. For example, the auxiliary battery 122 is positioned within the body 110 and cannot be removed. In some embodiments, the auxiliary battery 122 is not user replaceable, and the auxiliary battery 122 may be replaced by a service center, e.g., an authorized service center. As discussed in detail herein, the main battery 120 recharges the auxiliary battery 122 such that the auxiliary battery 122 does not need to be replaced or removed from within the power tool 100 and the auxiliary battery 122 is maintained at a sufficient charge level to power one or more functions, e.g., auxiliary functions, of the power tool 100, when the main battery 120 is removed for recharging.

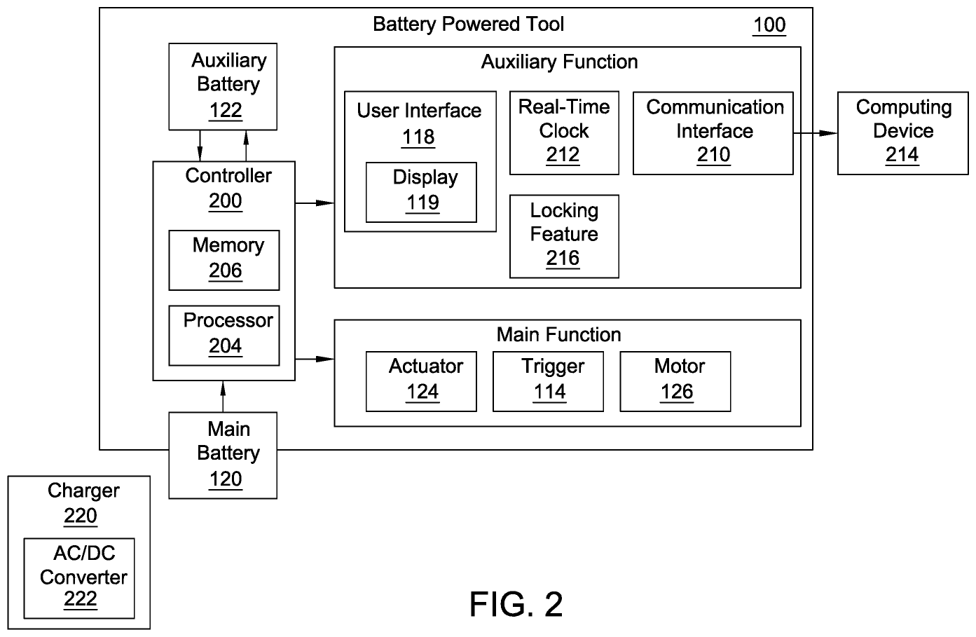

With reference to FIG. 2, the power tool 100 includes a controller 200 that is in electrical communication with both the main battery 120 and the auxiliary battery 122. The controller 200 is generally configured to control one or more functions or processes of the power tool 100 and/or monitor the main battery 120 and the auxiliary battery 122. The controller 200 regulates and controls the discharge of power from the main battery 120 and the auxiliary battery 122. The controller 200 may generally include any suitable computer and/or other processing unit, including any suitable combination of computers, processing units and/or the like that may be operated independently or in connection with one another.

The controller 200 may include one or more processor(s) 204 and associated memory device(s) 206 containing instructions that cause the processor 204 (i.e., “configure the processor” or “program the processor”) to perform a variety of computer-implemented functions (e.g., performing the calculations, determinations, and functions disclosed herein). As used herein, the term “processor” refers not only to integrated circuits, but also refers to a controller, a microcontroller, a microcomputer, a programmable logic controller (PLC), an application specific integrated circuit, and other programmable circuits. Additionally, the memory device(s) 206 of the controller 200 may generally be or include memory element(s) including, but not limited to, computer readable medium (e.g., random access memory (RAM)), computer readable non-volatile medium (e.g., flash memory), and/or other suitable memory elements. Such memory device(s) 206 may generally be configured to store suitable computer-readable instructions that, when implemented by the processor(s), configure to, or causes the controller 200 to perform various functions including, but not limited to, controlling the tool 100, controlling operation of the tool attachment 116, providing output to the user interface 118, communications, main and auxiliary battery charging, and/or various other suitable computer-implemented functions.

The power tool 100 may include one or more actuators 124, connected to a motor 126, not shown in FIG. 1, for operating the tool attachment 116. For example, in the illustrated embodiment, the tool attachment 116 may be a crimping tool attachment 116 that is selectively positionable using the actuator 124 in an open position allowing a fitting to be inserted into the crimping tool attachment 116 and a closed, crimped, position to perform the crimping function forming a mechanical joint, for example only, a plumbing mechanical joint. Additional and/or alternative applications for a different tool attachment 116 may include forming an electrical termination, cutting materials, hole forming, and the like, that are suitable for power tools 100.

In some embodiments, for example, the controller 200 receives user input from the user interface 118 of tool 100, and controls one or more functions of tool 100 in response to such user inputs. The user interface 118 may include input devices (e.g., buttons or knobs) enabling a user to selectively turn on or off one or more functions of the tool 100. The user interface 118 may include a display 119, such as a screen, a light, and/or a LED, for displaying information to a user. The user interface 118 may include a speaker for presenting audio information to the user. For example, the speaker may present a warning noise, indicating to a user that the main battery 120 has a charge level that does not meet one or more charge criteria. For example, the user interface 118 may indicate that a charge level of the main battery 120 or the auxiliary battery 122 has dropped below a certain threshold.

The controller 200 includes a communications interface 210. The communications interface 210 allows the tool 100 (and more particularly, the controller 200) to communicate with remote devices, e.g., a computing device 214, and/or systems as part of a wired or wireless communication network. Wireless network interfaces may include a radio frequency (RF) transceiver, a Bluetooth® adapter, a Wi-Fi transceiver, a ZigBee® transceiver, a near field communication (NFC) transceiver, an infrared (IR) transceiver, and/or any other device and communication protocol for wireless communication. The Bluetooth® adapter may be a Bluetooth® low energy (BLE) radio. (Bluetooth is a registered trademark of Bluetooth Special Interest Group of Kirkland, Washington; ZigBee is a registered trademark of the ZigBee Alliance of San Ramon, California.) Wired network interfaces may use any suitable wired communication protocol for direct communication including, without limitation, USB, RS232, I2C, SPI, analog, and proprietary I/O protocols. Moreover, in some embodiments, the wired network interfaces include a wired network adapter allowing the computing device 214 to be connected to a network, such as the Internet, a local area network (LAN), a wide area network (WAN), a mesh network, and/or any other network to communicate with remote devices and systems via the network.

The controller 200 transmits and receives communications over the communication network using messages formatted according to an appropriate network communication protocol. In some embodiments, the network communication protocol is an Ethernet communication protocol or an Institute of Electrical and Electronics Engineers (IEEE) 802.11 based communication protocol. In some embodiments, the communications interface 210 includes wired and wireless communications interfaces. In some embodiments, the communications interface 210 includes a wired communication interface for communicative connection to a communication interface in an automobile.

The communications interface 210 may be used, for example, for communicating diagnostics information, providing the serial number of the tool 100, providing maintenance performed information, providing firmware version information, receiving firmware updates, and reprogramming, and providing actuator 124 operation/fault status information to a diagnostic/monitoring device, or the like.

The tool 100 may further include a real-time clock 212. The real-time clock may be an integrated circuit that maintains a date and time, e.g., using a crystal. The tool 100 may further include an antitheft feature, such as a tool locking feature 216, the prevents user inputs and/or use of the tool 100, when the locking feature 216 is powered and enabled. The antitheft feature may include the controller 200 transmitting a signal to the user interface 118 causing the user interface 118 to display an indication, e.g., illuminate a symbol, indicating that the power tool 100 is locked. The antitheft feature may include the controller 200 connecting to the computing device 214 in order to enable unlocking by an authorized user or an owner of the power tool 100. For example, the user interface 118 may display a red solid light, indicating that the tool is locked or inoperable and a solid yellow connectivity light indicating that the user should connect the computing device 214 to the power tool 100.

The main battery 120 is selectively connectable, electrically and/or mechanically, to the power tool 100, enabling the main battery 120 to be removed from the power tool 100 for a charging operation. The main battery 120 may be recharged using a power source that is separate from the power tool 100, e.g., a charger 220. The charger 220 is configured to supply electrical power to the main battery 120. The charger 220 may have an AC/DC converter 222 enabling the charger 220 to convert an AC power source, such as AC electricity from a household or a commercial wall outlet, to DC power in order to recharge the main battery 120. The main battery 120 suitably includes an electrical connector enabling the main battery 120 to be directly connected to the charger 220. In some embodiments, the main battery 120 may be directly connected to an AC power source for recharging. For example, the main battery 120 may include an integral AC/DC converter. The controller 200 suitably includes one or more DC power converters or regulators configured to control or regulate DC power supplied by the charger 220. Such power converters and regulators may be incorporated or integrated within components of the tool 100.

The tool 100 powers one or more main functions and one or more auxiliary functions. The main function may include controlling the actuator 124 to perform one or more functions of the tool attachment 116. In the illustrated embodiment, the main function of the tool 100 includes crimping, e.g., to form a mechanical joint. The auxiliary functions may support and/or supplement the main function of the power tool 100. In some embodiments, the auxiliary function may include presenting information to an operator of the power tool 100, via the user interface 118. The auxiliary function may include presenting information to the user regarding a remaining battery life of one, or both, of the main battery 120 or the auxiliary battery 122.

The auxiliary functions may include communication, using the communication interface 210, advertising, e.g., with one or more external computing devices 214, such as a near-by mobile phone. Auxiliary functions may also include reading from and updating the real-time clock 212. Auxiliary functions may also include writing information, e.g., date/time, allowable run-time, allowable cycles, etc., to an external flash memory of the memory 206 and/or a memory of the computing device 214. The auxiliary function may include updating and/or maintaining the real-time clock 212. Maintaining the real-time clock 212, may include the controller 200 transmitting one or more signals with one or more external devices, e.g., a cloud-based service and/or the external computing device 214. Additionally, and or alternatively, the auxiliary function may include powering and/or enabling the locking feature 216. Enabling the locking feature 216 may include the controller 200 communicating with a computing device, e.g., an external computing device 214 or a cloud-based service, to exchange information, such as allowable run-time, a date and time the tool is allowed to run until, or allowable number of cycles. The auxiliary function may be any suitable function that enables the tool 100 to function as described herein.

The auxiliary battery 122 of this embodiment may be at a voltage that is less than the voltage of the main battery 120. In some embodiments, the auxiliary battery 122 may be at a voltage that is less than 10 volts, less than 5 volts, and/or less than 3 volts. In other embodiments, the auxiliary battery 122 may be at any suitable voltage that is sufficient to power the auxiliary function of the power tool 100. The auxiliary battery 122 may have an energy capacity less than 10 Watt-hour, or less than 1.0 Watt-hour. The main battery 120 may be at a voltage that is greater than or equal to 10 volts, which is greater than or equal to 15 volts, or greater than or equal to 18 volts, or greater or equal to 54 volts. The main battery 120 may have an energy capacity of greater than 25 Watt-hour, greater than 40 Watt-hour or greater than 215 Watt-hour. The ratio between the energy capacity of the auxiliary battery 122 to the main battery 120 may be less than 0.25, or less than 0.10, or less than 0.01. The main battery 120 may discharge a voltage that is suitable to power at least one of the main functions and/or the auxiliary function. Additionally, the main battery 120 may discharge a voltage that is suitable to simultaneously power the main function, the auxiliary function, and/or recharge the auxiliary battery 122.

The main battery 120 is at a voltage and energy capacity that is suitable to power the main functions of the power tool 100. In addition, the main battery 120 may also be at a voltage and have an energy capacity that is suitable to power the auxiliary functions of the power tool 100. In the illustrated embodiment the main battery 120 may be at a voltage and have an energy capacity that is suitable to power both the main functions and the auxiliary functions, simultaneously. In addition, the main battery 120 may be at voltage and have an energy capacity that is suitable to recharge the auxiliary battery 122. The main battery 120 may also recharge the auxiliary battery 122 simultaneously while the main battery 120 is powering the main functions. The main battery 120 may be at a voltage and have an energy capacity that is suitable to recharge the auxiliary battery 122 while the main battery 120 is powering both the main functions and the auxiliary functions. The main battery 120 may also recharge the auxiliary battery 122 when the main battery 120 is not powering the main functions.

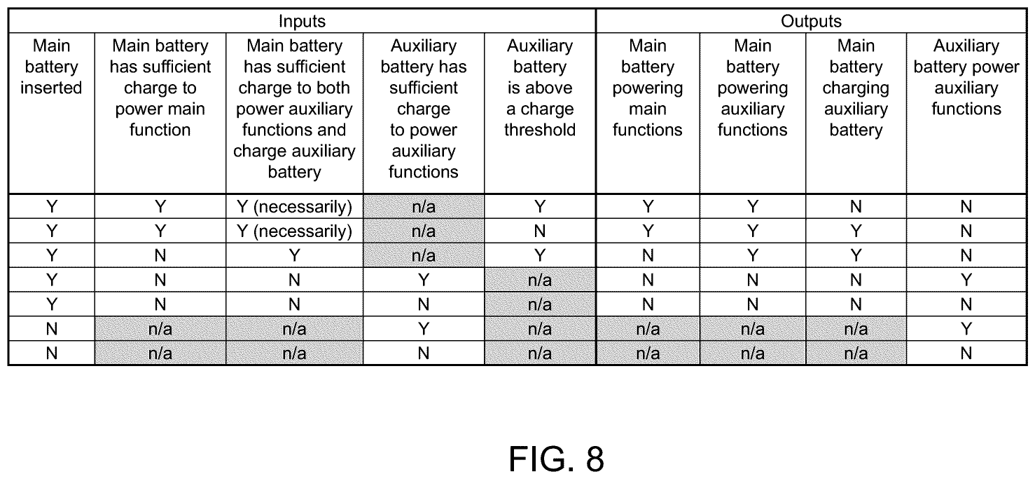

The controller 200 controls the supply of power from the main battery 120 and/or the auxiliary battery 122 to power the main function and or the auxiliary function, using one or more of a detected conditions. See FIG. 8. For example, the controller 200 may determine if the main battery 120 is connected or disconnected. The controller 200 may determine if the main battery 120 has sufficient charge to power the main function, sufficient charge to power the auxiliary function, or sufficient charge to power both the main function and the auxiliary function. The controller 200 may also detect if the main battery 120 has a charge above a threshold charge. The controller 200 may also detect if the auxiliary battery 122 has sufficient charge to power the auxiliary function or is above a threshold charge. Based on the detected conditions, the controller 200 may cause the main battery 120 and/or the auxiliary battery 122 to power the main and/or the auxiliary functions, as described herein. The controller 200 of the tool 100 may include one or more power converters or regulators configured to control or regulate the electrical power supplied to components of the tool 100, such as the main function and or the auxiliary function. The controller 200 may also control or regulate the supply of power by either the main battery 120 and/or the auxiliary battery 122 in response to a user input received from a power switch for example and or a speed selection switch of the user interface 118.

The controller 200 may determine or detect a charge level, e.g., a voltage or state of charge of the main battery 120 and the auxiliary battery 122. The controller 200 may determine, e.g., by comparing, if a charge level satisfies one or more charge criteria. In some embodiments the controller may determine the charge level by communicating directly with a separate controller (not shown) within the main battery 120. The controller 200 may communicate with the separate controller using a Universal Asynchronous receiver-transmitter (UART) or any suitable device-to-device communication protocol. The controller 200 may use a UART or other device-to-device communication protocol to exchange information, e.g., a charge level, with the main battery 120 or the auxiliary battery 122. In some embodiments, the controller 200 may determine a rate of change of a charge level of the main battery 120 and the auxiliary battery 122. The controller 200 may be able to determine if the main battery 120 is electrically connected, or electrically disconnected, to the power tool 100. For example, if the controller 200 determines that the main battery 120 is electrically connected to the power tool 100 and the controller 200 also determines that the main battery 120 has a charge level that satisfies one or more charge criteria, the controller 200 will supply power from the main battery 120 to power both the main function and the auxiliary function. For example, if the controller 200 determines that the main battery 120 is electrically disconnected from the power tool 100 or, alternatively, if the controller 200 determines that the main battery 120 has a charge level that does not meet the charge criteria, the controller 200 will supply power from the auxiliary battery 122 to the auxiliary functions. The controller 200 may also determine if the auxiliary battery 122 has a charge threshold that satisfies one or more charge criteria.

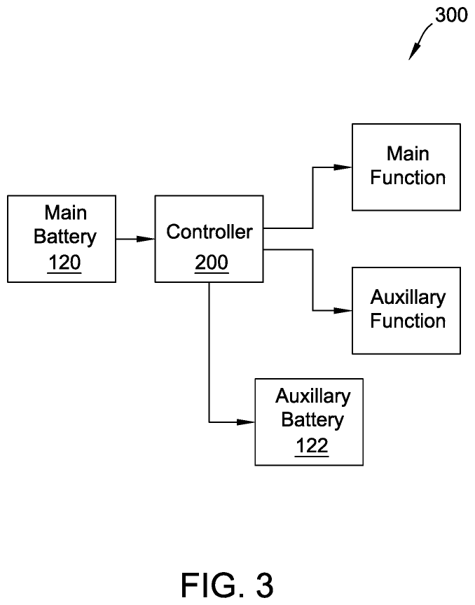

In reference to the control system 300 shown in FIG. 3, the controller 200 may control the supply of power from the main battery 120, causing the main battery 120 to power both the main functions and the auxiliary functions simultaneously. The main battery 120 also recharges the auxiliary battery 122. The main battery 120 may recharge the auxiliary battery 122, while simultaneously, the main battery 120 powers both the main function and the auxiliary function.

In the control system 300, the controller 200 may compare a charge level of the main battery 120 to one or more different predetermined criteria. If the controller 200 determines that the charge level of the main battery 120 satisfies the criteria, the controller 200 may determine that the main battery 120 has sufficient charge to power both the main functions and the auxiliary functions while simultaneously recharging the auxiliary battery 122. If the controller 200 determines that the charge level of the main battery 120 does not satisfy the one or more criteria, e.g., a charge threshold, the controller 200 may determine that the main battery 120 does not have sufficient charge to power both the main function and the auxiliary function while simultaneously charging the auxiliary battery 122. If the controller 200 determines that the main battery 120 does not satisfy one or more of the charge criteria, the controller 200 may cause the main battery 120 to power only the main functions. For example, in some embodiments, if the controller 200 determines that the main battery 120 does not have sufficient charge the controller 200 may cause the main battery 120 to only power the main functions and the auxiliary functions and not recharge the auxiliary battery 122.

The controller 200 may determine that the main function is not currently being powered, and then the controller 200 causes the main battery 120 to recharge the auxiliary battery 122. In some embodiments, the controller 200 may only charge the auxiliary battery 122 using the main battery 120, when the main battery 120 is not being used to power main functions. The controller 200 may cause the main battery 120 to power auxiliary functions, and not main functions, when the main battery 120 is recharging the auxiliary battery 122.

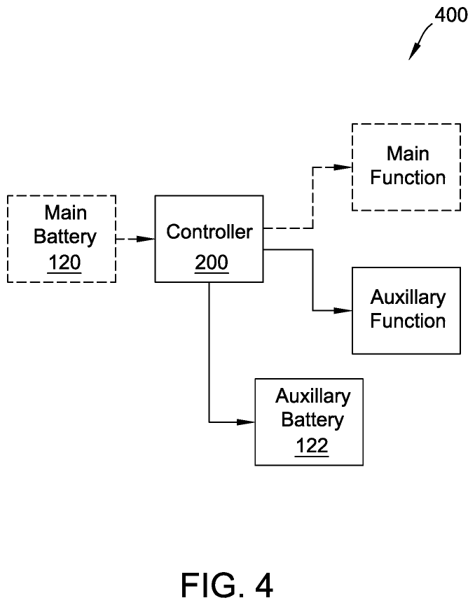

FIG. 4 illustrates another control system 400 for controlling the power tool 100. The controller 200 may determine that the main battery 120 has been electrically disconnected from the power tool 100 and then the controller 200 may control the power discharged by the auxiliary battery 122 causing the auxiliary battery 122 to power the auxiliary functions. The controller 200 may only cause the auxiliary battery 122 to power the auxiliary functions when the main battery 120 is electrically disconnected from the power tool 100. Alternatively, the controller 200 may cause the auxiliary battery 122 to power the auxiliary functions when the main battery 120 is electrically connected to the power tool 100 but the main battery 120 does not have sufficient charge to power both the main and auxiliary functions. Alternatively, or additionally, the controller 200 may cause the auxiliary battery 122 to power the auxiliary functions when the main battery 120 is electrically connected to the power tool 100 and the main battery 120 is powering the main functions.

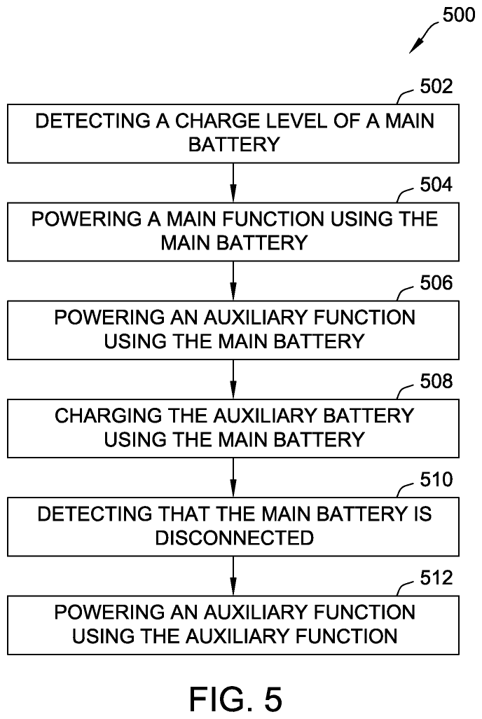

FIG. 5 shows an example process 500 for powering main and auxiliary functions of the power tool 100. The process includes detecting 502 a charge level of the main battery 120. The process 500 may further include comparing the detected 502 charge level of the main battery 120 to one or more charge criteria. The process 500 may include the controller 200 determining if the main battery 120 is electrically connected to the power tool 100. If the controller 200 determines that the main battery 120 is both electrically connected to the tool 100 and satisfies the charge level criteria, the process 500 includes powering 504 the main function using the main battery 120. Process 500 may include determining that the main battery 120 is both electrically connected to the tool 100 and satisfies the charge level criteria, and powering 506 the auxiliary functions of the power tool 100. Process 500 may include powering 504 the main functions and powering 506 the auxiliary functions using the main battery 120, simultaneously.

If the controller 200 determines that the main battery 120 is electrically connected but does not satisfy the charge level criteria, the controller 200 may cause the main battery 120 to power only the main functions. If the controller 200 determines that the main battery 120 does not satisfy the charge level criteria, process 500 may include presenting one or more messages to an operator using the user interface 118. For example, process 500 may include the controller 200 transmitting one or more messages to the user interface 118 causing the user interface 118 to display a battery warning message to a user, indicating the charge level of the main battery 120 and/or prompting the user to disconnect the main battery 120 for performing a recharging operation.

Process 500 may include charging 508 the auxiliary battery 122 using the main battery 120. In some embodiments, process 500 may include the controller 200 causing the main battery 120 to recharge the auxiliary battery 122 when the main battery 120 is powering at least one of the main functions and/or the auxiliary functions. Alternatively, and/or additionally, the process 500 may include the controller 200 detecting that the main battery 120 is not being used to power the main functions, and then causing the main battery 120 to recharge the auxiliary battery 122.

Process 500 may also include the controller 200 detecting 510 that the main battery 120 has been electrically disconnected from the tool 100. If the controller 200 determines that the main battery 120 is electrically disconnected, process 500 may include powering 512, using the auxiliary battery 122, the auxiliary functions. Powering 512 the auxiliary functions may include the controller 200 detecting a charge level of the auxiliary battery and comparing the detected charge level to one or more charge criteria. If the controller determines that the charge level of the auxiliary battery satisfies the charge criteria, process 500 includes powering 512 the auxiliary functions using the auxiliary battery. If the controller determines that the charge level does not satisfy the charge criteria, process 500 may include causing the user interface 118 to indicate to a user that the auxiliary battery is low, for example.

Alternatively, process 500 may include powering the main functions using the main battery 120 and powering the auxiliary functions using the auxiliary battery 122.

Process 500 may include the controller 200 comparing a charge threshold of at least one of the main battery 120 and/or the auxiliary battery 122 to one or more criteria. The one or more criteria may be preselected based on the power required for the main functions, auxiliary functions, and/or charging the auxiliary battery 122. The criteria may be a charge threshold. The controller 200 may detect a charge level of the main battery 120 and compare the detected charge level of the main battery 120 to the charge threshold. If the controller 200 determines that the charge level is less than the charge threshold, the controller 200 may prevent and/or stop the main battery 120 from recharging the auxiliary battery 122.

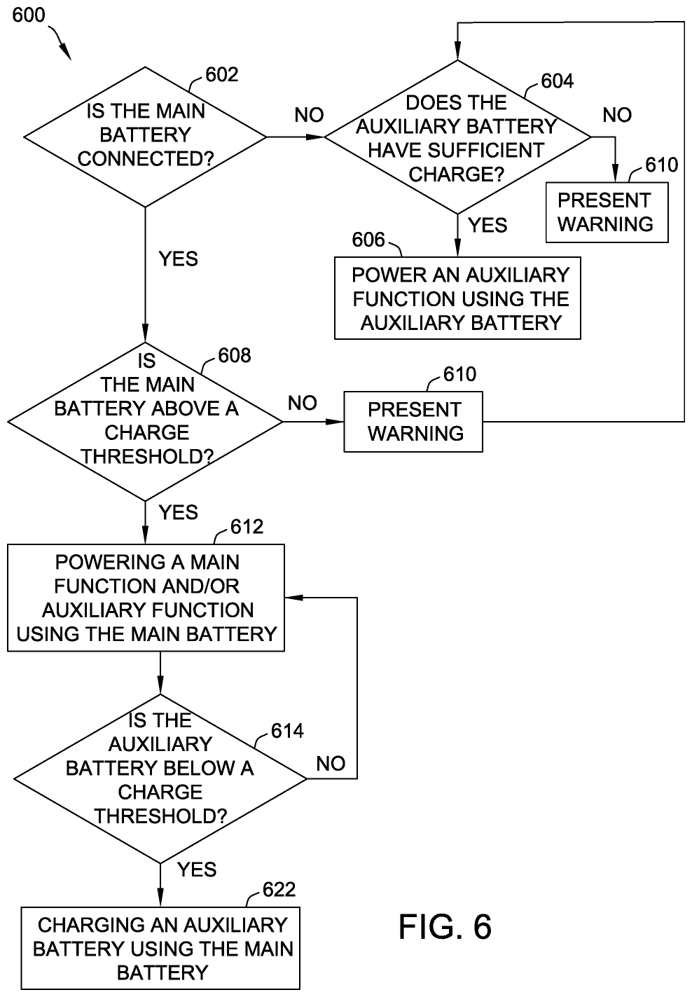

FIG. 6 shows an example process 600 for powering main and auxiliary functions of the power tool 100. The process 600 may include detecting 602, e.g., by the controller 200, if the main battery 120 is connected to the power tool 100. If the main battery 120 is detected 602 as not being connected to the power tool 100, the controller 200 may detect 604 if the auxiliary battery 122 has sufficient charge to power auxiliary functions. Detecting 604 may include the controller 200 detecting if the auxiliary battery 122 has a charge level above a threshold criteria. If the auxiliary battery 122 is detected 604 to have sufficient charge, the controller 200 may cause the auxiliary battery 122 to power one or more auxiliary functions. If the auxiliary battery 122 is detected 604 to not have sufficient charge, the process 600 may include the controller 200 causing the power tool 100 to present 610 a warning, e.g., causing the user interface 118 to display a warning to the user indicating that the auxiliary battery 122 does not have sufficient charge or displaying a recommendation to connect the main battery 120.

If the controller 200 detects 602 that the main battery 120 is connected to the power tool 100, then process 600 may include detecting 608 if the main battery 120 has sufficient charge and/or if a charge level of the main battery 120 is above a threshold criteria. If the main battery 120 is detected 608 to have sufficient charge, the controller 200 may cause the main battery 120 to power 612 the main function and/or the auxiliary function. If the controller 200 detects 608 that the main battery 120 does not have sufficient charge, e.g., sufficient charge to power the main function, the auxiliary function, and/or both the main function and the auxiliary function, the controller 200 may cause the power tool 100 to present 610 a warning, e.g., such as causing the user interface 118 to display a warning to the user indicating that the main battery 120 does not have sufficient charge or displaying a recommendation to recharge the main battery 120. In some embodiments, process 600 may include, after detecting 608 that the main battery 120 does not have sufficient charge, the controller 200 may cause the auxiliary battery 122 to power the auxiliary functions. Process 600 may include, after detecting 608 that the main battery 120 does not have sufficient charge, the controller 200 may detect 604 if the auxiliary battery 122 has sufficient change, and if the auxiliary battery 122 has sufficient charge, the controller may cause the auxiliary battery 122 to power auxiliary functions.

Process 600 may include detecting 614, by the controller 200, if the auxiliary battery 122 has sufficient charge. Detecting 614 may include detecting 614, while the main battery 120 is connected to the power tool 100. If the controller 200 detects 614 that the auxiliary battery 122 does not have sufficient charge or has a charge level below a threshold criteria, then the controller 200 may cause the main battery 120 to charge the auxiliary battery 122. If the controller 200 detects 614 that the auxiliary battery 122 does have sufficient charge, or has a charge level above a threshold criteria, then the controller 200 may not cause the main battery 120 to charge the auxiliary battery 122.

Embodiments and examples of the power tool, have improvements over other known power tools. The power tool described herein includes a main battery that is removable for recharging and an auxiliary battery that is fixed internally within the body of the tool and that is rechargeable using the main battery. The power tool has main functions, e.g., an operation performed by the tool, and auxiliary functions, e.g., real-time clock and/or a locking feature, which supplements the main function of the tool. Even when the main battery is removed from the tool, e.g., for charging, the auxiliary features are still available and are powered using the auxiliary battery. In addition, the auxiliary battery is fixed within the power tool and does not need to be replaced or removed for recharging, as the main battery automatically recharges the auxiliary battery. The main battery has sufficient energy capacity to power the main function, and the auxiliary function, while simultaneously recharging the auxiliary battery. The controller may wait until the main battery is not powering the main functions to recharge the auxiliary battery such that a power level for performing the main function is maintained.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing(s) shall be interpreted as illustrative and not in a limiting sense.

What is claimed is:

1. A battery system for powering a power tool having an electrically powered main function and an electrically powered auxiliary function, wherein the battery system comprises:
a removable main battery connectable to the power tool;
an auxiliary battery for powering the auxiliary function, wherein the auxiliary battery is fixed within a cavity defined by a housing of the power tool; and
a controller connected to the main battery and the auxiliary battery, wherein
if the controller detects that the main battery is connected to the power tool, the controller causes the main battery to charge the auxiliary battery and the controller causes the main battery to power both the main function, and
if the controller detects that one of i) the main battery is disconnected from the power tool, and ii) the main battery has a charge level less than a predetermined threshold, the controller causes the auxiliary battery to power the auxiliary function.

2. The battery system of claim 1, wherein the main battery has an energy capacity greater than the energy capacity of the auxiliary battery.

3. The battery system of claim 1, wherein the main battery is at a voltage that is greater than or equal to 10V and wherein the main function requires a voltage that is greater than or equal to 10V.

4. The battery system of claim 1, wherein the auxiliary battery is at a voltage that is less than 10V and wherein the auxiliary function requires a voltage that is less than 10V.

5. The battery system of claim 1, wherein the main battery includes an electrical connector for selectively electrically connecting to at least one of the power tool and a charger for recharging the main battery when the main battery is electrically disconnected from the power tool.

6. The battery system of claim 1, wherein the main battery charges the auxiliary battery when the main battery is not powering the main function.

7. The battery system of claim 1, wherein if the controller detects that the main battery is connected to the power tool, the controller causes the main battery to charge the auxiliary battery and the controller causes the main battery to power both the main function and the auxiliary function

8. The battery system of claim 1, wherein the auxiliary function includes at least one of a real-time clock, a communication interface, a user interface, and a display.

9. The battery system of claim 1, wherein the power tool is at least one of a hydraulic crimping tool, a cutting tool, a pipe threading tool, a pipe fabrication tool, a drain cleaning machine, a conduit bending machine, a cable pulling machine, a grinder, a drill/driver, a nail gun, a saw, and an impact driver.

10. A power tool system comprising:
a power tool having an electrically powered main function and an electrically powered auxiliary function, wherein the power tool includes a cavity defined by a housing;
a removable main battery connectable to the power tool;
an auxiliary battery for powering the auxiliary function, wherein the auxiliary battery is fixed within a cavity defined by a housing of the power tool; and
a controller connected to the main battery and the auxiliary battery, wherein
if the controller detects that the main battery is connected to the power tool, the controller causes the main battery to charge the auxiliary battery and the controller causes the main battery to power the main function, and
if the controller detects that one of i) the main battery is disconnected from the power tool, and ii) the main battery has a charge level less than a predetermined threshold, the controller causes the auxiliary battery to power the auxiliary function.

11. The power tool system of claim 10, wherein the main battery has an energy capacity greater than the energy capacity of the auxiliary battery.

12. The power tool system of claim 10, wherein the main battery is at a voltage that is greater than or equal to 10V and wherein the main function requires a voltage that is greater than or equal to 10V.

13. The power tool system of claim 10, wherein the auxiliary battery is at voltage that is less than 10V and wherein the auxiliary function requires a voltage that is less than 10V.

14. The power tool system of claim 10, wherein the main battery includes an electrical connector for selectively electrically connecting to at least one of the power tool and a charger for recharging the main battery when the main battery is electrically disconnected from the power tool.

15. The power tool system of claim 10, wherein the main battery charges the auxiliary battery when the main battery is not powering the main function.

16. The power tool system of claim 10, wherein the main battery has an energy capacity that is at least 4 times the energy capacity of the auxiliary battery.

17. A method comprising:
detecting if a main battery is one of i) disconnected from a power tool, and ii) has a charge level less than a predetermined threshold;
if the main battery is detected as being connected, charging an auxiliary battery by the main battery, and powering a main function and an auxiliary function of the power tool using the main battery; and
if the main battery is detected as being disconnected or has a charge level less than a predetermined threshold, powering the auxiliary function of the power tool using the auxiliary battery.

18. The method of claim 17, wherein the method comprises:
disconnecting the main battery from the power tool and connecting the main battery to a power source to charge the main battery.

19. The method of claim 17, wherein charging the auxiliary battery by the main battery comprises:
detecting if the main battery is powering the main function; and
if the main battery is detected as not powering the main function, charging the auxiliary battery by the main battery.

20. The method of claim 17, wherein charging the auxiliary battery by the main battery comprises:
detecting if the main battery is powering at least one of the main function and the auxiliary function; and
if the main battery is detected as not powering the main function, charging the auxiliary battery by the main battery.
